(19) United States
(12) Patent Application Publication
(10) Pub. No.: US 2017/0232947 A1
(43) Pub. Date: Aug. 17, 2017

(54) Electrohydraulic Assembly and Brake System

(71) Applicant: CONTINENTAL TEVES AG & CO. OHG, Frankfurt (DE)

(72) Inventors: Andreas HEISE, Erhausen (DE); Jurgen SCHERSCHMIDT, Munchen (DE)

(73) Assignee: CONTINENTAL TEVES AG & CO. OHG, Frankfurt (DE)

(21) Appl. No.: 15/127,225

(22) PCT Filed: Mar. 15, 2015
(86) PCT No.: PCT/EP2015/054817

§ 371 Date: Mar. 24, 2017

(30) Foreign Application Priority Data
Mar. 18, 2014 (DE) 102014204981.4

(51) Int. Cl. B60T 8/36; B60T 8/32; B60T 13/14

(52) U.S. Cl. CPC B60T 8/368; B60T 13/142; B60T 8/3225

(57) ABSTRACT

Electrohydraulic assembly for a brake system, having a hydraulic unit comprising a housing body which houses electrically actuable valves and a hydraulic pump having an electric drive apparatus for the pump, having an electronic unit arranged on the housing body for controlling the valves and/or the drive apparatus, and having a pressure medium reservoir which comprises a first space for pressure medium, a vented second space and a media-separating element that separates the first space from the second space, wherein the pressure medium reservoir is connected to a suction side of the pump, and wherein the pressure medium reservoir is embodied as a pressure medium supply reservoir to keep pressure medium ready for the pump for increasing brake pressure or while the pump increases brake pressure, and brake system having such an assembly.

### TECHNICAL FIELD

The invention relates to an electro-hydraulic assembly and also to a brake system.

### BACKGROUND OF THE INVENTION

DE 10 2007 047 202 A1 discloses an electro-hydraulic assembly for a slip-controlled vehicle brake system having a receiving body which comprises valve bores and a pump, having an electric motor for driving the pump and having an electronic control unit flange-mounted to the receiving body for controlling the electric motor and/or hydraulic valves. In addition, the receiving body exhibits bores for low-pressure reservoirs having spring-loaded pistons, wherein the piston separates a hydraulic region from an atmospheric region of the low-pressure reservoir. The low-pressure reservoirs are used for receiving only temporarily pressure medium which, for example, is released from the wheel brakes during an anti-lock control and is then recirculated. When the assembly is in the operating state or the vehicle is idling, the low-pressure reservoirs are empty. The atmospheric region of the low-pressure reservoir is outwardly ventilated via a ventilation channel to the surrounding atmosphere, wherein the ventilation channel ends on the side of the receiving body lying opposite the electronic control unit.

Hydraulic brake systems for different motor vehicles such as, for example, two-wheeled or four-wheeled vehicles, are known in the art. The future will see an increasing number of motor vehicles arriving on the market in which braking can not only be initiated by the driver by means of a foot-operated or hand-operated brake actuation element, but also automatically by a vehicle system. Automated braking is, in particular, an absolute prerequisite for vehicles with a highly automated driving operation or with an autonomous driving operation, wherein the vehicle drives automatically and without driver involvement. In order to guarantee adequate safety in this respect, greater demands must be made of the electrically controllable, hydraulic brake actuator mechanism of the brake system.

Brake systems are known in the art in which an actuator operated by electromotive means conveys pressure media into one or a plurality of wheel brakes. An important aspect for brake systems of this kind is that sufficient pressure medium is present, in order to be able to actuate the wheel brakes. It is known in the art for pressure media to be drawn from a pressure medium storage reservoir connected to the actuator via a pipe or hose line.

A motorcycle brake system emerges from DE 10 2012 214 586 A1, for example, in which a rear wheel brake has pressure applied to it through activation of a pump driven by means of an electric motor, wherein the pump arranged in an electro-hydraulic assembly makes the necessary pressure medium available via a remotely disposed pressure medium storage reservoir.

A brake-by-wire brake system for motor vehicles is known from WO 2012/143313 A1 having a first electro-hydraulic module with a pump and a second module with a main brake cylinder and a further pressure source, wherein the second module is assigned a pressure medium storage reservoir. In this case, the pump is connected by the second module on the suction side to the pressure medium storage reservoir.

The disadvantage of the aforementioned brake systems is that a rapid suction of pressure medium is only possible to a limited extent, or not at all, on account of the flow properties of the pressure medium and also the limited cross section and length of the suction line and possibly the components arranged in said suction line, such as valves.

The problem addressed by the present invention is therefore that of supplying a brake system and an electro-hydraulic assembly with a pump for a brake system which allows a rapid supply of pressure medium by the pump.

### SUMMARY

This problem is solved according to the invention by an electro-hydraulic assembly and also a brake system.

The basic idea underlying the invention is that of providing at least one pressure medium reservoir in the electro-hydraulic assembly which is configured as a pressure medium storage reservoir for keeping pressure medium available for the pump for a build-up of brake pressure by means of the pump or during a brake pressure build-up by means of the pump.

The advantage of the invention is that the assembly can be used in different brake systems, wherein pressure medium is made available for the pump largely unhindered and independently of the remaining brake system design. Even if faults occur in a brake line leading to the assembly, e.g. a rupture of the brake line, a brake line according to the invention can still build up brake pressure, at least temporarily.

The pressure medium reservoir is preferably filled with pressure medium when the electro-hydraulic assembly is in an idle state or a standby state, so that sufficient pressure medium is available for the next brake application.

According to a development of the invention, the second chamber is connected via a ventilation means to an inner space arranged between the receiving body and a housing of the electronic unit, i.e. the second space of the pressure medium reservoir is ventilated towards the inner space of the electronic unit. This means that there is a sufficient clean air volume for feeding into the second space in the event of pressure medium being removed from the first space. Particularly preferably, the inner space is the region of the electronic unit in which electrical and/or electronic components are arranged.

In order to generate no suction resistance or only a small amount, the air-filled volume of the inner space is preferably a multiple of the volume of the first space.

In order to reduce the suction resistance further and/or to avoid pressure differences resulting from thermal expansion, at least one means for ventilating the inner space of the electronic unit is preferably provided in the housing of the electronic unit. Particularly preferably, this comprises a gas-permeable and, advantageously, liquid-impermeable membrane element.

The pressure medium reservoir is preferably configured in such a manner that the pressure medium reservoir is refilled independently once pressure medium has been removed from the pressure medium reservoir.

In order to collect leaks, a pressure medium-absorbing, advantageously sponge-like, element is provided in a region in which the pressure medium reservoir is arranged to the inner space of the electronic unit. The element may collect any small leaks.

According to a preferred embodiment of the assembly according to the invention, a detection device for detecting or monitoring a filling level of the pressure medium reservoir is provided. This is particularly preferably arranged in a region between the receiving body and the housing of the electronic unit, advantageously in the region of the ventilation medium of the second space.

It is preferable for the detection device to comprise a first sensor element which is arranged in the electronic unit and a second element which is secured to the media-separating element. This allows a simple and direct sensing of the movement or position or location of the media-separating element and therefore of a filling level of the pressure medium reservoir.

The pressure medium reservoir is preferably configured as a bellows reservoir which comprises a supporting body and a flexible media-separating element, wherein the supporting body and the flexible media-separating element delimit the second space. The supporting body is particularly preferably made of metal.

The supporting body is preferably arranged on the side of the receiving body of the hydraulic unit facing the electronic unit. This allows simple ventilation of the second space of the pressure medium reservoir to the inner space of the electronic unit.

Alternatively, it is preferable for the pressure medium reservoir to be configured as a piston accumulator with a piston as the media-separating element.

The means for ventilating the second space is preferably a bore or a ventilation channel. Particularly preferably, the bore or the ventilation channel is arranged in the supporting body of the pressure medium reservoir.

The invention also relates to a brake system with an electro-hydraulic assembly according to the invention. This is a brake system for a motorcycle or for a motor vehicle having a brake actuation element and hydraulically actuable wheel brakes.

The pressure medium reservoir of the electro-hydraulic assembly is preferably configured in such a manner that the pressure medium volume kept ready in the pressure medium reservoir is sufficient to actuate the wheel brake or the wheel brakes which is or are connected to the pressure medium reservoir, in order to cross an air gap and to perform an operating brake application on the wheel brake or the wheel brakes. By means of the pressure medium reservoir, at least one emergency brake application can therefore be performed independently of the other pressure medium supply to the brake system.

The brake system preferably comprises, in addition to the pressure medium reservoir(s) integrated in the electro-hydraulic assembly, a pressure medium reservoir connected at atmospheric pressure which is connected or connectable to the pressure medium reservoir. The pressure medium storage reservoir is used for the suction of pressure medium into the pressure medium reservoir(s) of the electro-hydraulic assembly.

Alternatively or in addition, the brake system preferably comprises in addition to the pressure medium reservoir(s) integrated in the electro-hydraulic assembly/assemblies a pressure medium display means that can be read by a user or by the vehicle driver, for example, which is connected or connectable to the pressure medium reservoir. The pressure medium display means is particularly preferably configured as an inspection glass or window. The pressure medium display means is used for the visual inspection of the pressure medium level.

According to a development of the brake system according to the invention, this comprises a pressure generator with at least one pressure outlet connection, wherein the pressure outlet connection is connected or connectable to the pressure medium reservoir(s). The pressure medium reservoir is particularly preferably configured to be high-pressure-resistant, when pressure can be applied on the input side. The pressure generator is particularly preferably configured as a main brake cylinder that can be actuated by means of the actuating element or as an electrically actuable pressure generator.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings, wherein like reference numerals refer to like parts, in which:

FIG. 1 an exemplary motorcycle brake system with a first exemplary embodiment of an electro-hydraulic assembly according of the present invention;

FIG. 2 an exemplary vehicle brake system with a second exemplary embodiment of an electro-hydraulic assembly of the present invention;

FIG. 3 an exemplary vehicle brake assembly with a third exemplary embodiment of an electro-hydraulic assembly of the present invention;

FIG. 4 a detail of the exemplary embodiment in FIG. 3; and

FIG. 5 a detail of a fourth exemplary embodiment of an electro-hydraulic assembly of the present invention.

### DETAILED DESCRIPTION

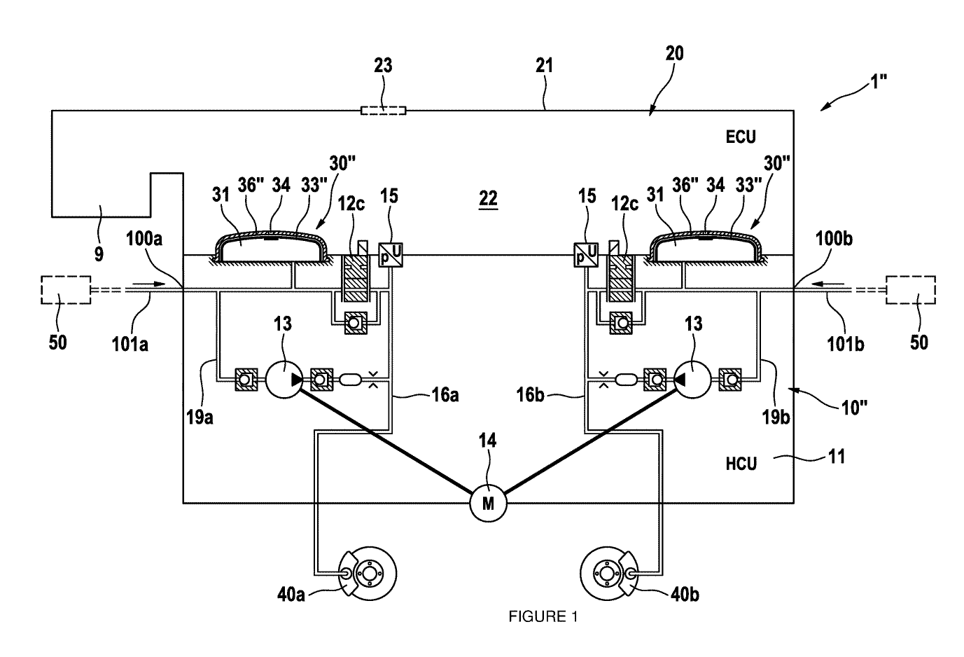

FIG. 1 shows an exemplary motorcycle brake system as a schematic representation with a first exemplary embodiment of an electro-hydraulic assembly according to the invention. The brake system comprises a first hydraulically actuable wheel brake 40a assigned to the front wheel (VR) and also a second hydraulically actuable wheel brake 40b assigned to the rear wheel (HR).

The front wheel brake 40a is hydraulically actuable by means of a main brake cylinder 2 which is actuable by means of a brake actuation element 3 (e.g. a handbrake lever) by a driver. A pressure medium storage container 4a at atmospheric pressure is assigned to the main brake cylinder 2. Electromagnetically actuable inlet and outlet valves 12a, 12b are used for brake slippage control in the front wheel brake circuit I, wherein the inlet valve 12a opened (open in a powerless state) is inserted in the brake line 16a of the front wheel brake circuit I which connects the main brake cylinder 2 to the front wheel brake 40a. The outlet valve 12b which is closed (normally closed) in the normal position is inserted into a return line 17 of the brake circuit I, which connects the front wheel brake 40a to a low-pressure reservoir 18 and one of the suction sides of a piston pump 13 divided into two circuits which works on the basis of the recirculation principle. The associated pressure side of the piston pump 13 is connected upstream of the inlet valve 12a to the brake line 16a, so that a needs-based recirculation of the pressure medium volume released from the front wheel brake 40a into the low-pressure reservoir 18 is guaranteed. When the brake system is in the idle state, the low-pressure reservoir is normally empty.

By way of example, the rear wheel brake 40b can only be actuated electrically. The brake actuation element 5 for actuating the rear wheel brake (e.g. a foot brake lever) is coupled with a simulator 6 for this purpose, which provides the driver with a familiar brake lever feeling. By means of a detection device 7, an actuation path or angle of the brake actuation element 5 or, alternatively, an actuation path of part of the force/path simulator 6, is detected. The signal from the detection device 7 is supplied to an electronic unit (ECU, electrical/electronic control unit) 20 of the electro-hydraulic assembly 1 of the brake system, by means of which a corresponding control of the piston pump 13 for the build-up of pressure at the rear wheel brake 40b can be performed. The suction side of the pump 13 of the rear wheel brake circuit II is connected via a suction line 19b to a second pressure medium storage reservoir 4b (or a second chamber 4b of the pressure medium storage reservoir) and also to a pressure medium reservoir 30. The associated pressure side of the piston pump 13 is connected via a brake line 16b of the rear wheel brake circuit II to the rear wheel brake 40b. Parallel to the piston pump 13 is arranged a separating valve 12c which is open (normally open) in the normal position, so that the rear wheel brake 40b is connected to the pressure medium storage reservoir 4b and the pressure medium reservoir 30 when the separating valve 12c is open. In order to build up pressure in the rear wheel brake 40b by means of the pump 13, the separating valve 12c is closed and pressure medium conveyed into the rear wheel brake 40b by means of the pump 13.

By way of example, the piston pump 13 of the motorcycle brake system has a valve switching for each brake circuit I, II with a suction valve not referred to in greater detail and a pressure valve not referred to in greater detail which are preferably configured as spring-loaded check valves.

The electro-hydraulic assembly 1 comprises a hydraulic unit (HCU) 10 with a receiving body 11, the electronic unit 20 with a housing 21 and an electrical drive device 14, e.g. an electric motor, for the pump. The electronic unit 20 is arranged on the receiving body 11, so that an inner space 22 is created between the housing 21 and receiving body 11 in which, by way of example, electrical and/or electronic components of the electronic unit 20, such as an evaluation circuit for the detection device 7 signal and/or valve coils for the electromagnetic actuation of the valves 12a, 12b, 12c, are arranged. The electronic unit 20 is connected via an electrical system plug 9 to an electrical energy source and, advantageously, to a vehicle data bus. By way of example, the receiving body 11 receives the electrically actuable valves 12a, 12b, 12c, the piston pump 13, the low-pressure reservoir 18, the pressure medium reservoir 30 and also, for each brake circuit I, II, a pressure sensor 15 assigned to the wheel brake 40a, 40b. Further pressure sensors may be present (not shown in FIG. 1), which are then likewise received by the receiving body 11.

The pressure medium reservoir 30 comprises a first chamber 31 for pressure medium, a ventilated second chamber 32 and a media-separating element 33 which separates the first chamber 31 from the second chamber 32.

By way of example, the pressure medium reservoir 30 is configured as a bellows reservoir with elastomer. In this case, the pressure medium reservoir 30 comprises a supporting body 36 which is of cylindrical design, for example, and is made of metal, in which the media-separating element 33 made of elastomer is arranged. For the ventilation of the second chamber 32, a ventilation means, e.g. a bore 34, is present in the supporting body 36, through which the second chamber 32 is connected to the inner space 22 of the electronic unit 20. The pressure medium reservoir 30 therefore constitutes a bellows-attributed brake fluid reservoir with ventilation opening.

The pressure medium reservoir 30 represents a pressure medium storage reservoir for keeping pressure medium available for the pump 13 of the rear wheel brake circuit II. For or during a brake pressure build-up at the rear wheel brake 40b, the pressure medium reservoir 30 supplies the pressure medium for actuation of the rear wheel brake 40b by means of the pump 13. Accordingly, the pressure medium reservoir 30 is filled with pressure medium in its idle state or in its normal state.

If pressure medium volume is removed from the first chamber 31 of the pressure medium reservoir 30 by the pump 13, a corresponding air volume is drawn out of the inner space 22 into the second chamber 32. The pressure medium reservoir 30 is advantageously of self-feeding design.

In the exemplary embodiment of the bellows reservoir with elastomer, the media-separating element 33 is moved by intrinsic material stresses back into the initial position, as soon as there is no longer any suction effect prevailing due to the pump 13, so that the pressure medium reservoir 30 is refilled, e.g. from the pressure medium storage reservoir 4b.

The exemplary motorcycle brake system in FIG. 1 is configured in such a manner that there is no significant feed pressure acting on the pressure medium reservoir 30. The pressure medium reservoir 30 is therefore designed in such a manner that the pressure medium reservoir 30 is preferably refilled independently by a small “inherent suction force”, once the pressure medium has been removed from the pressure medium reservoir 30.

FIG. 2 shows as a schematic representation an exemplary motorcycle brake system for a passenger vehicle with a second exemplary embodiment of an electro-hydraulic assembly according to the invention, for example. The brake system is of dual-circuit design. The break system either comprises only two hydraulically actuable wheel brakes 40a, 40b (the other wheel brakes of the passenger vehicle may be of electromechanically actuable design, for example) or it comprises two further assemblies of comparable design which are not shown, so that four hydraulically actuable wheel brakes can be actuated, wherein in FIG. 2 only one wheel brake 40a, 40b is depicted for each brake circuit I and II. An enlargement to more than four hydraulically actuable wheel brakes is of course possible accordingly.

By way of example, the electro-hydraulic assembly 1′ comprises a hydraulic unit (HCU) 10′ with a receiving body 11, an electronic unit 20 with a housing 21 and an electrical drive device 14, e.g. an electric motor, for driving a piston pump 13 divided into two circuits. The piston pump 13 may also be of multiple circuit design (three-circuit, four-circuit, etc. which are not shown). The electronic unit 20 is arranged on the receiving body 11, so that an inner space 22 is formed between the housing 21 and the receiving body 11, in which electrical and/or electronic components of the electronic unit 20 are arranged, for example, such as a detection and/or evaluating circuit for the signals from the pressure sensors 15 and also the control electronics of the valves 12c. The electronic unit 20 is connected via an electrical system plug 9 to an electrical power source and, advantageously, to a vehicle data bus.

For each brake circuit I, II, the assembly 1′ comprises an input connection 100a, 100b for a brake line 101a, 101b. The brake lines 101a, 101 may originate from a pressure generator 50 or various pressure generators (not shown); by way of example, a pressure generator 50 is depicted by dotted lines in FIG. 2. An initial pressure may therefore be applied to the brake lines 101a, 101b. For each brake circuit I, II the input connection 100a, 100b is connected to the assigned suction side of the piston pump 13 of the brake circuit I, II and also to the input connection of a normally open separating valve 12c connected in parallel to the pump. The pressure side of the piston pump 13 and the output connection of the separating valve 12c are each connected by means of the brake line 16a, 16b to the wheel brake 40a, 40b (or the wheel brakes).

The pressure generator 50 may, for example, be a brake pedal-actuable or brake pedal and electromechanically actuable main brake cylinder or a purely electrically actuable pressure source. A (further) brake control device (e.g. a conventional ESC [Electronic Stability Control] assembly with pump and valves), preferably with a plurality of output circuits, is also advantageous.

Furthermore, a pressure medium reservoir 30′ is provided for each brake circuit I, II which is connected to the suction side of the piston pump 13 in each case and which represents a pressure medium storage reservoir for keeping pressure medium available for the pump 13 of the respective brake circuit I, II.

If more than two wheel circuits are to be used, the subassembly elements may be of multiple configuration.

The pressure medium reservoirs 30′ are configured as piston reservoirs, for example. In a cylindrical recess in the receiving body 11, a piston is arranged as a media-separating element 33′ which separates a first chamber 31 for pressure media from a ventilated second chamber 32. In order to ventilate the second chamber 32, ventilation means 34 such as holes, for example, are provided in each case, through which air can flow from the inner space 22 of the electronic unit 20 into the second chamber 32. In other words, the pressure medium reservoirs 30′ are ventilated towards the electronic unit 20 or the inner space 22 thereof. An air volume corresponding to the pressure medium volume removed from the pressure medium reservoir 30′ can thereby be removed from the air volume present between the hydraulic unit (HCU) 10′ and electronic unit 20. The pressure medium reservoir 30′ therefore constitutes a piston-attributed brake fluid reservoir.

The pressure medium reservoir 30′ is high-pressure-resistant and is filled in the idle state.

The pressure medium reservoir 30′ is a balanced pressure reservoir.

The pumps 13 for each brake circuit I, II may draw pressure medium out of the pressure medium reservoirs 30′ independently of one another via the suction line 19a, 19b.

The electronic unit 20 or else the inner space 22 thereof is advantageously ventilated towards the atmosphere. For this purpose, a means for ventilation 23 is arranged in the housing 21 of the electronic unit 20. For example, a membrane element 23 or a plurality of membrane elements is arranged in the housing 21. The membrane element is gas-permeable (ventilation membrane) and advantageously liquid-impermeable.

By way of example, the receiving body 11 accommodates the electrically actuable valves 12c, the piston pump 13, the pressure medium reservoir 30′ and also the pressure sensors 15.

In brake systems in which a brake pressure (e.g. initial pressure) can arise on the line section lying in the suction path of the pump, the pressure medium reservoir 30′ is advantageously configured as a high-pressure-resistant volume reservoir (volume dispenser) which admittedly allows slight suction but otherwise receives no pressure medium volume wherever possible during normal operation, except for the refilling of the pressure medium reservoir 30′, so as to avoid impeding normal brake operation. So that the smallest possible volume uptake can be achieved, the volume reservoir and the sealing cap thereof, for example, are of highly rigid design, i.e. they expand very little under pressure (e.g. made of metal).

FIG. 3 shows by way of example as a schematic representation a motor vehicle brake system for a passenger vehicle, for example, with a third exemplary embodiment of an electro-hydraulic assembly according to the invention. The brake system substantially corresponds to the brake system in FIG. 2, wherein only the pressure medium reservoirs 30″ of the electro-hydraulic assembly 1″ are differently configured. The pressure medium reservoir 30″ constitutes an alternative bellows storage reservoir with ventilation opening, “self-restoring” elastomer mold part and optional detection device.

A detail of the hydraulic unit 10″ and the receiving body 11 with a pressure medium reservoir 30″ without a detection device is depicted in enlarged form in FIG. 4. In this case, FIG. 4a shows the pressure medium reservoir 30″ in the (completely) filled state and FIG. 4b shows the pressure medium reservoir 30″ in a part-empty state. The pressure medium reservoir 30″ comprises a supporting body 36″ and a media-separating element 33″ which separates a first chamber 31 with pressure medium from a second chamber 32 with air.

The media-separating element 33″ is configured as a “self-restoring” elastomer mold part or a “self-restoring” elastomer mold body, for example.

The supporting body 36 is formed by a metal cover, for example, which is secured at the hydraulic unit 10″ to the surface facing the electronic unit 20 (e.g. caulked or screwed). The supporting body is configured as a flat, arched cover, for example. The supporting body may, for example, be secured to the hydraulic unit 10″ by caulking, for example. In the supporting body 36, a ventilation means 34 in the form of a ventilation opening is provided, through which the second chamber 32 is connected to the inner space 22 of the electronic unit 20 (not shown in FIG. 4).

When the bellows reservoir (FIG. 4a) is in the completely filled state, the media-separating element 33″ is supported by the supporting body 36″. The elastomer molded part 33″ is relaxed.

Optionally, the pressure medium reservoir 30″ is provided with a detection device for identifying the filling level of the reservoir. In FIG. 5, a detail of a fourth exemplary embodiment of an electro-hydraulic assembly according to the invention is represented schematically. Except for the additional detection device 35, the electro-hydraulic assembly corresponds to the electro-hydraulic assembly 1″ in FIG. 3. In the interests of transparency, of the hydraulic unit 10″ and the components thereof, only the part of the receiving body 11 which represents one of the pressure media reservoirs 30″ with detection device 35 is depicted in FIG. 5. The valves 12c, the pump 13, the drive device 14, the lines 16a, 16b, 19a, 19b (except for a short section of the suction line to the pressure medium reservoir 30″) and the pressure sensors 15 are not represented. FIG. 5a shows the pressure medium reservoir 30″ in a (completely) filled state and FIG. 5b in a partially empty state.

In the inner space 22, which is formed between the housing 21 of the electronic unit 20 and the receiving body 11, a printed circuit board 24 is depicted, for example, on which electrical and/or electronic components of the electronic unit 20 are arranged and which is connected to the electrical system plug 9.

The detection device 35 comprises, for example, a first sensor element 37 and a second element 38, wherein the first sensor element 37 is arranged on the printed circuit board 24 in the region of or opposite the ventilation means (the opening/bore) 34 in the supporting body 36″ and the second element 38 is secured in the region of the ventilation means 34 to the media-separating element 33″. The sensor element 37 and the element being sensed 38 interact with one another, so that an approach or movement away from the first element 37 by the second sensor element 38 or else a space between the elements 37, 38 can be detected. The sensor element 37 therefore senses the position of the element 38.

The element 38 is preferably made of ferromagnetic metal.

By way of example, the second element 38 is rod or pin-shaped. In the completely filled state of the pressure medium reservoir 30″ (FIG. 5a), when the media-separating element 33″ is supported by the supporting body 36″, the second element 38 projects through the ventilation opening 34 into the inner space 22. The distance between the elements 37, 38 is then minimal. In the partially emptied state of the pressure medium reservoir 30″ (FIG. 5b), when the second chamber 32 has been enlarged and the second element 38 arranged on the media-separating element 33″ is therefore retracted, as it were, the distance between the elements 37, 38 is increased. The distance between the elements 37, 38 is therefore a measure of the filling level of the pressure medium reservoir 30″.

A corresponding detection device 35 may of course also be used accordingly in differently configured pressure medium reservoirs, e.g. the pressure medium reservoirs 30, 30′ according to the first and second exemplary embodiment.

In the electro-hydraulic assemblies according to the invention, the problems surrounding the “impeded suction capacity of pressure media” is solved in that one or more pressure medium volume reservoirs are provided in the assembly, which provides a pressure medium volume relevant to the wheel or brake circuit wholly or at least partially without significant suction resistance of the assembly pump. The pressure medium reservoir(s) is/are therefore located in the electro-hydraulic assembly/HCU, ECU performing the brake activity by means of the pump.

A pressure medium reservoir preferably supplies one or several cubic centimeters of pressure medium volume.

The pressure medium reservoir is preferably configured as a bellows reservoir or a piston reservoir.

In the case of a brake system in which an initial pressure can be applied to the pressure medium reservoir, the pressure medium reservoir does not necessarily exhibit resilience.

In the case of a brake system in which no significant initial pressure can be applied to the pressure medium reservoir, the pressure medium reservoir particularly preferably has a slight resilience, so that once the pressure medium volume has been drawn out, said reservoir is refilled independently.

The second space of the pressure medium reservoir will preferably be ventilated into the electronic unit or into the (inner) space in the assembly/control unit in which the electronics and the valve coils are normally housed. This has various advantages. In the control unit there is a clean area which is protected from contamination (dust, water, etc.). The space is also usually ventilated, in order to reduce excess and negative pressures (particularly due to temperature expansions, but also atmospheric air pressure fluctuations). A further advantage is the relatively large spatial volume of the inner space. Even in the unfavorable case in which air cannot flow back into the inner space quickly enough by ventilation, the suction resistance is only increased minimally.

The invention preferably relates to an electro-hydraulic motor vehicle or motorcycle brake system assembly which is independently capable of generating brake pressure having one or a plurality of integrated pressure medium volume reservoirs or pressure medium stores, wherein the pressure medium store is full of or is filled with pressure medium in the inoperative state and supplies the required pressure medium volume when pressure medium is drawn out, and a volume of air corresponding to the pressure medium volume drawn out is removed from a ventilated inner air volume of the electro-hydraulic assembly in which electronic and/or electromechanical components are fitted.

The pressure medium volume of the pressure medium reservoir is preferably greater in design terms than the pressure medium volume which is required in order to generate in the associated wheel brake(s) a sufficient brake pressure from the typical inoperative state and thereby to be able to brake the wheel(s).

The air volume of the electro-hydraulic assembly is preferably a multiple of, e.g. greater than ten times, the volume that can be removed by the pressure medium reservoir.

The pressure medium reservoir(s) is/are preferably fed by a supply line that can have brake pressure applied to it at least temporarily, which supply line can be supplied with pressure by a pressure generator upstream of the assembly. The pressure generator is particularly preferably another electro-hydraulic assembly or a brake pedal-actuated pressure generator or a vacuum-supported pressure generator.

The pressure medium reservoir is preferably supplied with pressure medium via a pressure medium container.

The pressure medium reservoir preferably comprises a supporting body, particularly preferably made of metal, and a media-separating element which delimits a ventilated space with the supporting body. The supporting body allows air to flow after into the space when pressure medium volume is drawn from the pressure medium reservoir.

The pressure medium reservoir is preferably configured as a bellows reservoir with a media-separating element made of elastomer which supplies the necessary pressure medium volume through deformation of the media-separating element within the separating body. Particularly preferably, the media-separating element is moved through intrinsic material stresses back into its initial position, as soon as there is no longer any prevailing suction effect.

Alternatively, it is preferable for the pressure medium reservoir to be configured as a piston accumulator.

The pressure medium store or else the pressure medium reservoir preferably comprises an elastic element, e.g. a spring, which performs a restoring action on the media-separating element delimiting the volume. The elastic element (e.g. spring) preferably pushes the media-separating element (e.g. the piston) away from the hydraulic unit, so that the media-separating element pushes the air volume back into the electronic unit. Sealing elements on the media-separating element (e.g. the piston) are configured in such a manner that during pressureless operation they allow a slight push-back but are able to withstand high pressures when pressure is applied from the hydraulic region, but receive little volume.

A sponge-like element is preferably arranged in the region outside the pressure medium reservoir in such a manner that pressure medium leaks emerging can be collected. The sponge-like element(s) is/are particularly preferably arranged about the ventilation means (e.g. opening 34) in the intermediate region between the hydraulic unit and the electronic unit.

The assembly preferably comprises an electronic sensor device or detection device which can be used to monitor the filling level or at least the “filled” state of the pressure medium store or else the pressure medium reservoir.

The pressure medium volume stored in the pressure medium reservoir(s) is preferably of such dimensions that sufficient pressure medium volume is available for at least one brake application in the associated brake circuit. Hence, for example, a brake application can still be performed with a punctured brake line which lies in the access path to the assembly.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

1-15. (canceled)

16. An electro-hydraulic assembly for a brake system having a hydraulic unit comprising:
a receiving body which accommodates electrically actuable valves and a hydraulic pump;
an electrical drive device for the pump;
an electronic unit arranged on the receiving body for actuation of the valves and the drive device;
a pressure medium reservoir which defines a first chamber having a pressure medium therein, a ventilated second chamber and a media-separating element which separates the first chamber from the second chamber;
wherein the pressure medium reservoir is connected to a suction side of the pump; and
wherein the pressure medium reservoir is configured as a pressure medium storage reservoir for keeping pressure medium available for the pump for one of a brake pressure build-up and during a brake pressure build-up by the pump.

17. The electro-hydraulic assembly of claim 16, wherein the pressure medium reservoir is filled with pressure medium when the electro-hydraulic assembly is in one of an idle state and a standby state.

18. The electro-hydraulic assembly of claim 16, wherein the second chamber is connected via a ventilation means to an inner space arranged between the receiving body and a housing of the electronic unit.

19. The electro-hydraulic assembly of claim 18 comprising a pressure medium-absorbing element provided in the pressure medium reservoir in a region proximate to the ventilation means.

20. The electro-hydraulic assembly of claim 19 wherein pressure medium-absorbing element is a sponge-like material.

21. The electro-hydraulic assembly of claim 16, wherein the air-filled volume of the inner space is at least twice the volume of the first chamber.

22. The electro-hydraulic assembly of claim 21, wherein the air-filled volume of the inner space is at least ten times the volume of the first chamber.

23. The electro-hydraulic assembly of claim 16, wherein the housing of the electronic unit includes a ventilation element from the inner space of the electronic unit.

24. The electro-hydraulic assembly of claim 23, wherein the ventilation element comprises at least one of a gas-permeable membrane element and a liquid-permeable membrane element.

25. The electro-hydraulic assembly of claim 16, comprising the pressure medium reservoir is configured in such a manner that the pressure medium reservoir is refilled independently once pressure medium has been removed from the pressure medium reservoir.

26. The electro-hydraulic assembly of claim 16 comprising a detection device for detecting a filling level of the pressure medium reservoir, wherein the detection device is arranged proximate to the receiving body and the housing of the electronic unit.

27. The electro-hydraulic assembly of claim 26, wherein the detection device comprises a first sensor element which is arranged in the electronic unit and a second element which is positioned on the media-separating element.

28. The electro-hydraulic assembly of claim 16, wherein the pressure medium reservoir is a bellows reservoir which comprises a supporting body, wherein the media-separating element is flexible, and wherein the supporting body and the media-separating element delimit the second chamber.

29. The electro-hydraulic assembly of claim 28, wherein the supporting body is metal.

30. The electro-hydraulic assembly of claim 16, wherein the pressure medium reservoir is a piston accumulator and the media-separating element is a piston.

31. A brake system for a motor vehicle comprising:
a brake actuation element;
at least one hydraulically actuable wheel brake; and
an electro-hydraulic assembly wherein at least one of wheel brakes is attached, the electro-hydraulic assembly further comprising;
a hydraulic unit having a receiving body which accommodates electrically actuable valves and a hydraulic pump;
an electrical drive device for the pump;
an electronic unit arranged on the receiving body for actuation of the valves and the drive device;
a pressure medium reservoir which defines a first chamber having a pressure medium therein, a ventilated second chamber and a media-separating element which separates the first chamber from the second chamber;
wherein the pressure medium reservoir is connected to a suction side of the pump; and
wherein the pressure medium reservoir is configured as a pressure medium storage reservoir for keeping pressure medium available for the pump for one of a brake pressure build-up and during a brake pressure build-up by the pump.

32. The brake system of claim 31, wherein the pressure medium volume that is kept ready in the pressure medium reservoir is sufficient to actuate the at least one wheel brake connected to the pressure medium reservoir to cross an air gap and to perform an operating brake application on the at least one wheel brake.

33. The brake system according to claim 31, comprising a pressure medium storage container connected at atmospheric pressure which is connectable to the pressure medium reservoir.

34. The brake system of claim 31 further comprising:
a pressure generator, particularly a main brake cylinder actuable by one of: the actuating element, an electrically actuable pressure generator and a vacuum-activatable pressure generator; and
wherein the pressure generator includes at least one pressure output connection, wherein the pressure output connection is connectable to the particularly high-pressure-resistant pressure medium reservoir.
